(19) United States
(12) Patent Application Publication
(10) Pub. No.: US 2024/0008533 A1
(43) Pub. Date: Jan. 11, 2024

(54) Shock Absorption in a Handheld Aerosol Generating Device

(71) Applicant: JT International SA, Geneva (CH)

(72) Inventors: Kyle Adair, Lisburn (GB); Peter Loveday, Epsom (GB); Olayiwola Olamiposi Popoola, Walton-on-Thames (GB)

(73) Assignee: JT International SA, Geneva (CH)

(21) Appl. No.: 18/020,559

(22) PCT Filed: Aug. 9, 2021
(86) PCT No.: PCT/EP2021/072159

§ 371 Date: Feb. 9, 2023

(30) Foreign Application Priority Data
Aug. 10, 2020 (EP) 20190300.2

(51) Int. Cl. A24F 40/40; A24F 40/10; F16F 7/00; H01R 13/24

(52) U.S. Cl. CPC A24F 40/40; A24F 40/10; F16F 7/003; H01R 13/2428

(57) ABSTRACT

A handheld aerosol generating device for delivering an aerosol upon heating a liquid includes an outer casing having a receiving cavity arranged for receiving a cartomizer; an electrical power supply device; an electrical connector arrangement being connected to the electrical power supply device and extending at least in part into the receiving cavity for supplying electrical power to an inserted cartomizer; and a deformable and energy absorbing element arranged to hold the electrical power supply device relative to the outer casing, wherein the deformable and energy absorbing element is electrically insulated from the electrical connector arrangement.

### CROSS REFERENCE

Any features essential to the applications titled “AEROSOL GENERATING DEVICE”, “SHOCK ABSORPTION IN A HANDHELD AEROSOL GENERATION DEVICE”, “AEROSOL GENERATING DEVICE WITH A SEALED CHAMBER FOR ACCOMMODATING A BATTERY”, “AEROSOL GENERATING DEVICE” and “AEROSOL GENERATING DEVICE WITH LIP SEAL FOR BATTERY DEGASSING MITIGATION” all filed Aug. 10, 2020, such as the claims thereof, and/or contained therein and corresponding to and/or relating to features of the present application are incorporated herein by this reference and can be combined with feature combinations disclosed herein in order to provide an improved aerosol generating device, and protection may be sought for the resulting feature combinations.

### TECHNICAL FIELD

The present invention relates to shock absorption in handheld aerosol generating devices. More particularly, the present invention relates to protecting internal components of handheld aerosol generating devices from damage when the device is subject to mechanical shock and stress, for example in situations in which a user let the device drop onto a relatively hard surface.

### BACKGROUND

In the arts there are known several types of handheld aerosol generating devices that include atomizers, vaporizers, electronic cigarettes, e-cigarettes, cigalikes, etc. Such devices usually comprise a compact casing so that a user can hold the device in a hand and can use the device in a comfortable and non-tiring fashion. The devices usually comprise an aerosol generating device for delivering an aerosol that a user can inhale (e.g. in the case of e-cigarettes). For the purpose of generating the aerosol from, for example, a liquid, the device comprises an electrical power supply device, such as a rechargeable battery.

In many configurations, the aforementioned electrical power supply device constitutes a considerable part of the mass of the entire device. When, for example, a handheld aerosol generating device drops onto a hard floor, the device is subject to mechanical shock and stress, and, in turn, the relatively heavy power supply device can be damaged. Likewise, other components and elements of the handheld aerosol generating device can be damaged even if they only contribute relatively little to the overall mass of the device. For example, the power supply device can be pushed against connectors, conductors, switches, printed circuit boards (PCB), active or passive components on a PCB, and the like. The resulting mechanical force onto such components may damage them or parts thereof, and, in turn, lead to more or less severe malfunction of the device.

In the arts there are handheld aerosol generating devices that feature for example an elastic cover applied to the external of the device casing, in the form of a sleeve of elastic material put over the pen-like device. Further, there are devices in which metallic springs hold the battery and establish electric connection thereto at the same time. However, such conventional solutions either do not sufficiently protect the internals of handheld aerosol generating devices or do cause further problems that arise from combining mechanical fixation and electrical conduction. Especially the latter, can severely interfere with power supply to the device as such.

There is therefore a need for improved shock absorption techniques in handheld aerosol generating devices that not only protect the internal components sufficiently well but also maintain electric and functional stability and reliability of handheld aerosol generating devices.

### SUMMARY

The mentioned problems and objects are met by the subject-matter of the independent claims. Further preferred embodiments are defined in the dependent claims.

According to one embodiment of the present invention, there is provided a handheld aerosol generating device for delivering an aerosol upon heating a liquid, the device comprising an outer casing comprising a receiving cavity arranged for receiving a cartomizer; an electrical power supply device; an electrical connector arrangement being connected to said electrical power supply device and extending at least in part into said receiving cavity for supplying electrical power to an inserted cartomizer; and at least one deformable and energy absorbing element arranged to hold the electrical power supply device relative to the outer casing.

Preferably the deformable and energy absorbing element is electrically insulated from the electrical connector arrangement.

In a preferred mode, the one end, the receiving cavity, a first bulkhead, a first deformable and energy absorbing element, the electrical power supply device, a second deformable and energy absorbing element, a second bulkhead, and a second end are arranged in this order along a principal direction of the elongated handheld aerosol generating device.

Other characteristics of the invention are described in the appended claims.

### BRIEF DESCRIPTION OF THE DRAWINGS

Embodiments of the present invention, which are presented for better understanding the inventive concepts but which are not to be seen as limiting the invention, will now be described with reference to the figures in which:

FIGS. 1A & 1B show schematic views of a handheld aerosol generating devices according to respective general device embodiments of the present invention;

FIGS. 2A to 2C show schematic views of handheld aerosol generating devices according to further device embodiments of the present invention;

FIG. 3 shows a schematic view of the handheld aerosol generating devices according to the further device embodiments of the present invention from another side focusing on further aspects;

FIGS. 4A to 4C show schematic views of configurations for deformable and energy absorbing elements according to respective embodiments of the present invention;
and

FIGS. 5A to 5D show schematic views of internal structures of deformable and energy absorbing elements according to respective embodiments of the present invention.

### DETAILED DESCRIPTION

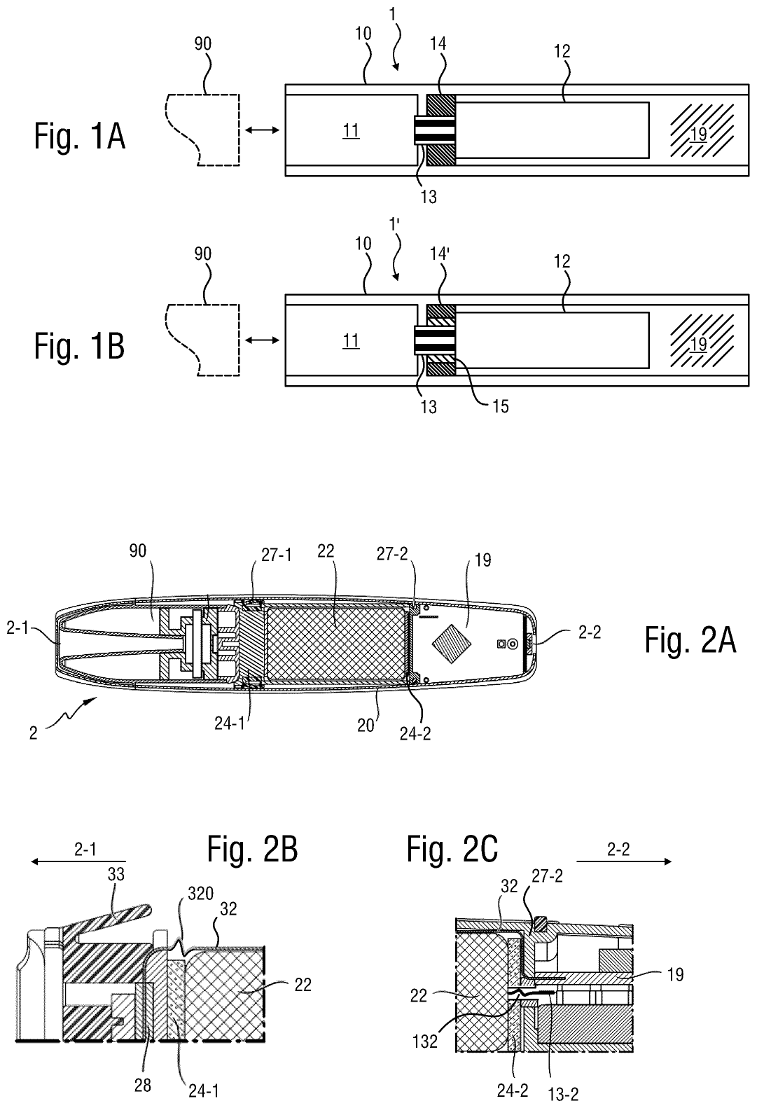

FIG. 1A shows a schematic view of a handheld aerosol generating device according to a general device embodiment of the present invention. The shown handheld aerosol generating device 1 is generally adapted for or suitable for delivering an aerosol upon heating a liquid. The handheld aerosol generating device 1 can be any one of an atomizer, a vaporizer, an electronic cigarette, an e-cigarette, a cigalike, etc., in which cases said aerosol can be inhaled by a user. The handheld aerosol generating device 1 comprises an outer casing 10 with a receiving cavity 11 arranged for receiving a cartomizer 90.

A cartomizer 90 is generally a cartridge that can be inserted in said receiving cavity 11 and that provides the functionalities of generating the aerosol from the liquid. For example, a cartomizer can be a pre-manufactured and pre-filled cartridge that comprises a reservoir of a liquid from which the aerosol can be generated. For the purpose of generating said aerosol, the cartomizer 90 may further comprise a heater which is arranged to heat at least a fraction of the liquid so as to vaporize an amount of the liquid for, in turn, generating the aerosol. The heater may comprise any one and combination of a wire, a resistive element, a coil, and a susceptor being heatable by induction. The cartomizer 90 may further comprise an air conduct and/or a mouthpiece so as to allow a user to inhale the generated aerosol, preferably as a mixture with air from the environment.

The handheld aerosol generating device 1 further comprises an electrical power supply device 12 and an electrical connector arrangement 13 being connected to said electrical power supply device 12. The supply device 12 can be any one of a battery, a rechargeable battery, a lithium-ion battery, a fuel cell, a super-capacitor and the like. Generally, the supply device 11 can be rechargeable or replaceable, and as far as the former is concerned, wire-bound or wireless charging may be accomplished by further circuitry arranged in area/space 19 or elsewhere in the device 1.

The electrical connector arrangement 13 is configured to extend at least in part into said receiving cavity 11 for supplying electrical power to an inserted cartomizer 90. For this purpose, the cartomizer 90 may further comprise an electric connector which is configured to connect or connect and engage with a part of the electrical connector arrangement 13 that extend at least in part into said receiving cavity 11. It is to be noted that an extension into the receiving cavity 11 does not imply that a protrusion must exist in the cavity 11, but merely requires that at least a part of the electrical connector arrangement 13 is accessible from within the receiving cavity 11 so that an electrical connection may be established between the arrangement 13 and an inserted cartomizer 90.

The handheld aerosol generating device 1 further comprises at least one deformable and energy absorbing element 14 arranged to hold the electrical power supply device 12 relative to the outer casing 10. The deformable and energy absorbing element 14 is electrically insulated from the electrical connector arrangement 13 by, for example, an insulating element or section arranged between the deformable and energy absorbing element 14 and the electrical connector arrangement 13, such as an insulating sleeve, and/or by forming said deformable and energy absorbing element 14 entirely or at least in part of an electrically insulating material. In this way, shock absorption can be provided in relation to the electrical power supply device 11 while avoiding any electric interference to the electrical connector arrangement 13 in case of physical contact or pressure exerted by the deformable and energy absorbing element 14 to the electrical connector arrangement 13.

FIG. 1B shows a schematic view of another handheld aerosol generating device according to a general device embodiment of the present invention. The shown handheld aerosol generating device 1′ is generally identical or similar to the handheld aerosol generating device 1 shown and explained in conjunction with FIG. 1, so for the common aspects and features the same corresponding reference numerals are used. However, the shown handheld aerosol generating device 1′ of this embodiment employs the teaching that a deformable and energy absorbing element 14′ is spaced apart from said electrical connector arrangement 13 by a distance space 15. This latter distance space 15 first provides electrical insulation between the deformable and energy absorbing element 14′ and the electrical connector arrangement 13 but also provides some safety margin when the deformable and energy absorbing element 14′ deforms during shock absorption. The distance space may further provide a fluid-tight arrangement between the electrical connector arrangement and the energy absorbing element 14′. This embodiment therefore also avoids any electric interference to the electrical connector arrangement 13 in case of shock absorption by avoiding or at least reducing physical contact or pressure exerted by the deformable and energy absorbing element 14′ to the electrical connector arrangement 13. It should be noted that the electrical connector arrangement 13 can be formed of a pair of electrical connectors separated by a portion of the energy absorbing element 14′.

FIGS. 2A, 2B, and 2C show schematic views of another handheld aerosol generating device according to a further device embodiment of the present invention. The shown handheld aerosol generating device 2 can be in part identical or similar to the handheld aerosol generating devices 1 and 1′ already shown and explained in conjunction with FIGS. 1A and 1B. Therefore, the shown handheld aerosol generating device 2 comprises an outer casing 20 comprising a receiving cavity 21 arranged for receiving a cartomizer 92, an electrical power supply device 22, an electrical connector arrangement 23, and deformable and energy absorbing elements 24-1 and 24-2.

This configuration may additionally consider a sealed air inlet for providing air intake from the environment and a printed circuit board 19 for holding and implementing remaining functionalities such as charging, heating control, general device control, parameter setting, user feedback and the like. In this embodiment, however, the electrical power supply device 23 is mounted relative to the outer casing 20 through the intermediary of an internal frame part 27-1 and 27-2. The internal frame parts 27-1 and 27-2 can be implemented as a front bulkhead 27-1 and a rear bulkhead 27-2 arranged inside an elongate outer casing 20, preferably, with a circular or oval cross-section. In other related embodiments, the internal frame part(s) are substituted, replaced or accompanied by a board structure, such as a printed circuit board.

In other words, in this embodiment the handheld aerosol generating device 2 is configured such that the first end 2-1, the receiving cavity and possibly the cartomizer 90, the first bulkhead 27-1, the first deformable and energy absorbing element 24-1, the electrical power supply device 22, the second deformable and energy absorbing element 24-2, the second bulkhead 27-2, and the second end 2-2 are arranged in this order along a principal direction of the elongated handheld aerosol generating device 2. In a way, there is therefore formed a battery compartment for the electrical power supply device 22 between the first bulkhead 27-1 and the second bulkhead 27-2. Further, electrical connectors can be placed on a printed circuit board (PCB) on one or both of the respective opposite sides of the bulkhead 27-1/27-2 or a corresponding frame's wall. Further, an electric connection can be made by a flexible printed circuit board 32 along the side of the electrical power supply device 22 (battery).

FIG. 2B shows a specific section of the handheld aerosol generating device according to the further device embodiment of the present invention. The shown section is in direction 2-1 relative to the electrical power supply device. Accordingly, the electrical power supply device 22 (battery) is in a compartment with front and rear bulkhead 27-1, 27-2 with deformable and energy absorbing elements 24-1 and 24-2 in the form of shock absorbing pads in-between. The electrical connectors are placed on a printed circuit board (PCB) 28 on the opposite side of the bulkhead or frame's wall. A connection toward the rear parts of the device may be established by means of a flexible PCB 32 running along the side of the electrical power supply device 22. A seal 33 may be placed above and around the pins.

FIG. 2C shows a specific section of the handheld aerosol generating device according to the further device embodiment of the present invention. The shown section is in direction 2-2 relative to the electrical power supply device. Accordingly, the electrical power supply device 22 (battery) is again in a compartment with front and rear bulkhead 27-1, 27-2 with deformable and energy absorbing elements 24-1 and 24-2 in the form of shock absorbing pads in-between. The connection to the rear PCB 19 is made by a flexible PCB 32 running along the side of the battery 22 as in FIG. 2B. Toward the other side 2-2, the battery 22 is connected to the PCB 19 via a connector 13-2 through the absorbing pad 24-2. The pad 24-2 as the deformable and energy absorbing element is placed between the rear bulkhead 27-2 in the form of a transversal wall of the frame/casing and the electrical power supply device 22 (battery). In this way, absorbing elements 24-1 and 24-2 are positioned between the front and rear bulkheads and thus can keep the battery 22 in a floating arrangement so that the battery is not rigidly fixed to the casing or frame and can thus move to compensate for any shocks and sudden accelerations.

Generally, electrical connector arrangements, such as the one shown in the Figures with reference numerals 13, 13-2, 23, and 32, can comprise a flexible conductor and/or be made of a flexible material, such as the already mentioned flexible printed circuit board (PCB). In these embodiments, an electrical connector arrangement comprises a flexible substrate onto which one or more conducting traces are laminated. The latter can be in the form of a copper sheet, usually with a thickness in the range of tens of microns. Furthermore, the electrical connector arrangement can not only provide a flexible configuration but a deformable or expandable portion in the main direction, preferably a meandering portion that can further absorb a relative movement between the battery 22 and any other elements of the device. The meandering portion can be preferably arranged along a main axis of the device, e.g. so that it can absorb movement along a direction parallel to the directions 2-1, 2-2. In FIGS. 2B and 2C there are shown respective meandering portions 320 and 132. In a different possible embodiment, the deformable portion of the connector can be formed of two separate connector parts which are configured to be slidable one relative to the other in the main direction (not illustrated). For example, a first part can form a guiding part with a rectangular wall and a hollow cavity to allow a second part to slide in the hollow cavity of the first part in the main direction.

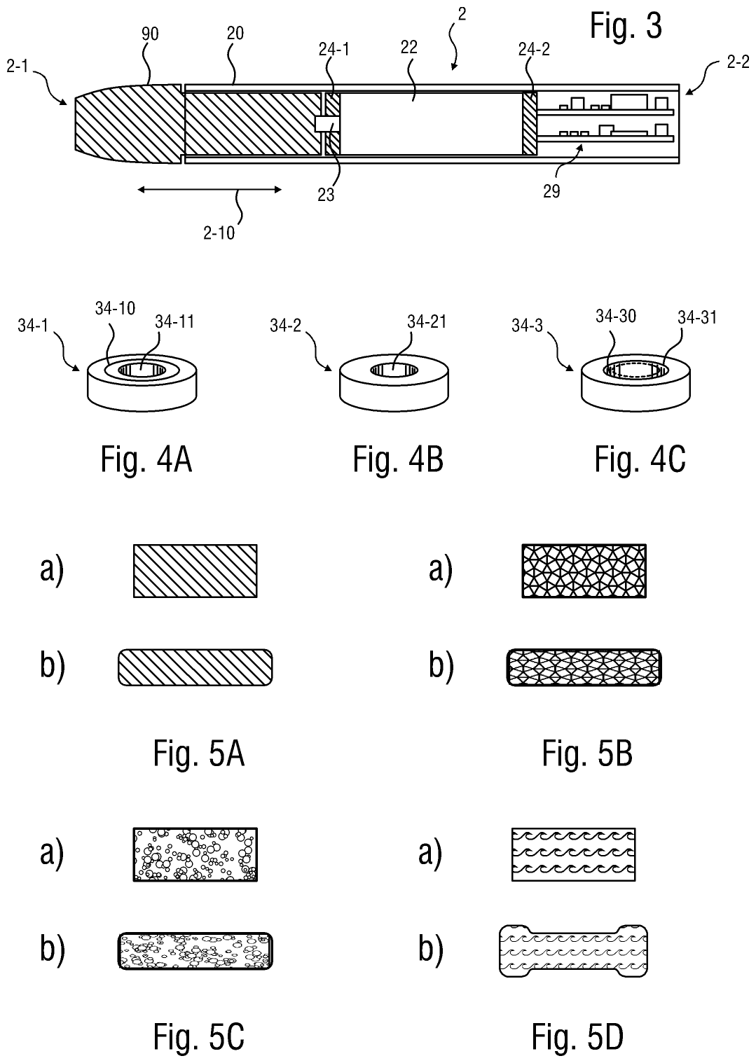

FIG. 3 shows the handheld aerosol generating device 2 of FIG. 2A in a more schematic way and from another side. In this schematic fashion a general situation for shock absorption may be explained: As shown, the handheld aerosol generating device 2 has elongated form or shape. In case the handheld aerosol generating device 2 is dropped, it is likely that the elongated form results in an impact of the device onto a hard surface, e.g. ground or floor, predominantly at either lateral end 2-1 or 2-2 seen relative to the main direction of extension 2-10.

As shown in this configuration, the relatively heavy electrical power supply device 22 may thus exert its inertia at the moment of impact predominantly in the direction 2-10 to—depending on whether the handheld aerosol generating device 2 impacts with end 2-1 or 2-2—parts at a side of the cartomizer 90, or—respectively, parts toward the circuitry 29. According to this embodiment at least two deformable and energy absorbing elements 24-1 and 24-2 are provided in an arrangement that follows the direction 2-10 in an order of the first device end 2-1, first deformable and energy absorbing element 24-1, electrical power supply device 22, second deformable and energy absorbing element 24-1, and second device end 2-2.

FIGS. 4A to 4C show schematic views of configurations for deformable and energy absorbing elements according to respective embodiments of the present invention. In FIG. 4A, there is shown a deformable and energy absorbing element 34-1 that comprises at least an electrically insulating section 34-10 toward the center of the element so as to surround an electrical contact arrangement inserted into the opening 34-11 of the deformable and energy absorbing element 34-1. In this way, more flexibility regarding the material of the deformable and energy absorbing element 34-1 can be obtained, since electrical insulation properties may no longer be relevant. Generally, a deformable and energy absorbing element may comprise at least an electrically insulating section toward the center of the element so as to surround an electrical contact arrangement inserted into the opening of the deformable and energy absorbing element.

In FIG. 4B, there is shown a deformable and energy absorbing element 34-2 that is formed of an electrically insulating material, so that opening 34-21 of the deformable and energy absorbing element 34-2 can reach up to and may even physically contact an electrical contact arrangement inserted into the opening 34-21.

In FIG. 4C, there is shown a deformable and energy absorbing element 34-3 that is formed of a suitable material that does not necessarily be an electrically insulating material: The opening 34-31 in this embodiment is dimensioned so that an electrical contact arrangement inserted into that opening 34-31 (dashed line) is still spaced apart by a distance 34-30 from the deformable and energy absorbing element 34-3. In this way not only more flexibility regarding the material of the deformable and energy absorbing element 34-3 can be obtained, but also a force exerted by or even physical contact at all of the deformable and energy absorbing element 34-3 to an electrical contact arrangement inserted into the opening 34-31 can be reduced or—respectively—avoided.

FIGS. 5A to 5D show schematic views of internal structures of deformable and energy absorbing elements according to respective embodiments of the present invention. Parts a) show the respective deformable and energy absorbing element in a relaxed undeformed state, wherein b) shows the deformed state in which the element has absorbed energy.

FIG. 5A shows schematically embodiments in which the deformable and energy absorbing element comprises any one of a elastomer, silicone, foamed polyurethane and/or foamed polyethylene material in a substantially solid form. FIG. 5B shows schematically embodiments in which the deformable and energy absorbing element comprises a cellular material, in which the energy to be absorbed is distributed to the deformation of individual cells of. Also in this embodiment, elastomer, silicone, foamed polyurethane and/or foamed polyethylene materials may apply. FIG. 5C shows schematically embodiments in which the deformable and energy absorbing element having viscoelastic properties comprises any one of material such as elastomer, silicone, polyurethane, polyethylene material and combinations thereof in an expanded or foamed form, preferably in a high-density foam such as polyethylene foam (e.g. Sorbothane®, Volara®) or open cell polyurethane foam. FIG. 5D shows schematically embodiments in which the deformable and energy absorbing element comprises a liquid absorbing material, which, preferably, is able to move and flow inside the element so as to distribute the force and energy. As far as the outer skin material of this possible “cushion-like” embodiment is concerned, again elastomer such as TPE (thermoplastic elastomer), silicone, and/or polyurethane, polyethylene materials may apply.

Although detailed embodiments have been described, these only serve to provide a better understanding of the invention defined by the independent claims and are not to be seen as limiting.

1. A handheld aerosol generating device for delivering an aerosol upon heating a liquid, the device comprising:
an outer casing comprising a receiving cavity arranged for receiving a cartomizer;
an electrical power supply device;
an electrical connector arrangement being connected to said electrical power supply device and extending at least in part into said receiving cavity for supplying electrical power to an inserted cartomizer; and
at least one deformable and energy absorbing element arranged to hold the electrical power supply device relative to the outer casing, wherein said at least one deformable and energy absorbing element is electrically insulated from the electrical connector arrangement.

2. The handheld aerosol generating device according to claim 1, further comprising an internal frame and/or a board, wherein the electrical power supply device is mounted relative to the outer casing through an intermediary of the internal frame and/or the board and said at least one deformable and energy absorbing element.

3. The handheld aerosol generating device according to claim 1, wherein said at least one deformable and energy absorbing element is spaced apart from said electrical connector arrangement.

4. The handheld aerosol generating device according to claim 1, wherein the electrical power supply device has an elongated form and the at least one deformable and energy absorbing element comprises at least two deformable and energy absorbing elements at either longitudinal end of the elongated electrical power supply device.

5. The handheld aerosol generating device according to claim 4, wherein at least two of the deformable and energy absorbing elements at the ends of the electrical power supply device allow in at least a longitudinal direction a floating movement s in a range of 0.5-4 mm.

6. The handheld aerosol generating device according to claim 1, wherein the device has an elongated form and the receiving cavity is arranged at one end of the device.

7. The handheld aerosol generating device according to claim 1, wherein a first end of the device, the receiving cavity, a first bulkhead, a first of the at least one deformable and energy absorbing element, the electrical power supply device, a second of the at least one deformable and energy absorbing element, a second bulkhead, and a second end of the device are arranged in this order along a principal direction of the elongated handheld aerosol generating device.

8. The handheld aerosol generating device according to claim 1, wherein the electrical power supply device is mounted by the at least one deformable and energy absorbing element to allow at least one degree of mechanical freedom of the electrical power supply device relative to the outer casing.

9. The handheld aerosol generating device according to claim 1, further comprising a guiding member arranged to prevent a mechanical freedom of the electrical power supply device in a first direction of the device.

10. The handheld aerosol generating device according to claim 9, further comprising a stopper arranged to stop the movement of the electrical power supply device in a second direction of the device beyond a maximum displacement.

11. The handheld aerosol generating device according to claim 1, wherein each of the at least one deformable and energy absorbing element comprises any one of a viscoelastic and/or a cellular material, a liquid absorbing material, a high-density foam, an elastomer, and/or silicone, and/or polyurethane.

12. The handheld aerosol generating device according to claim 1, wherein the at least one deformable and energy absorbing element is a pad or a layer adhesively glued to the electrical power supply device.

13. The handheld aerosol generating device according to claim 12, wherein the at least one deformable and energy absorbing element is configured to be compressible between 1 and 3 mm.

14. The handheld aerosol generating device according to claim 1, wherein the electrical power supply device is a rechargeable battery or fuel cell.

15. The handheld aerosol generating device according to claim 1, wherein the electrical connector arrangement comprises a flexible conductor.

16. The handheld aerosol generating device according to claim 15, wherein the flexible conductor comprises a deformable or expandable portion along a main direction of the handheld aerosol generating device.

17. The handheld aerosol generating device according to claim 16, wherein the deformable portion is a meandering portion.

18. The handheld aerosol generating device according to claim 4, wherein at least two of the deformable and energy absorbing elements at the ends of the electrical power supply device allow in at least a longitudinal direction a floating movement in a range of 2-3 mm.

19. The handheld aerosol generating device according to claim 11, wherein the high-density foam is polyethylene or polyurethane foam.
